(19) United States
(12) Patent Application Publication
(10) Pub. No.: US 2016/0218585 A1
(43) Pub. Date: Jul. 28, 2016

(54) ELECTRIC POWER GENERATION AND BRAKE DEVICE

(71) Applicant: Yuan-Kwei TZENG, Miaoli City (TW)

(72) Inventor: Yuan-Kwei TZENG, Miaoli City (TW)

(21) Appl. No.: 14/603,045

(22) Filed: Jan. 22, 2015

(51) Int. Cl. H02K 5/24; H02K 7/00; H02K 11/00; H02K 1/17; H02K 11/04; F16C 32/04; H02K 7/102

(52) U.S. Cl. CPC H02K 5/24; F16C 32/0497; H02K 7/003; H02K 7/1021; H02K 1/17; H02K 11/046; H02K 11/0073

(57) ABSTRACT

An electric power generation and brake device disposed on a shaft includes: a wheel installed to the shaft and including a magnet; a stator unit installed to the shaft and including a stator body, a serrated portion and a coil, such that when the wheel rotates, the magnet rotates with respect to the stator unit to generate an alternating current; a rectifier unit connected to the stator unit for converting the alternating current into a direct current; a control panel connected to the rectifier unit; a waveform generator unit connected to the control panel for generating an inverted torque input signal; and a brake unit for receiving the direct current and the inverted torque input signal, and including a brake body, a serrated portion and a coil, and the brake unit is provided for braking the wheel, so as to resist vibration and reduce noise.

### FIELD OF THE INVENTION

The present invention relates to an electric power generation device, and more particularly to the electric power generation and brake device capable of resisting vibration to reduce electromagnetic noises.

### BACKGROUND OF THE INVENTION

With reference to FIG. 1 for a conventional power generation device 1, a power generator unit 3 is provided for generating alternating current continuously by rotating a wheel 2, and a rectifier 4 is provided for converting the alternating current into direct current, and then the direct current is supplied to a control panel 5. However, the control panel 5 requires a small amount of electric power for operation, so that a high power resistor 6 is used to consume the remaining electric power, and thus causing an issue of wasting power.

In addition, the conventional power generation device 1 adopts magnets of the wheel 2 and serrated portions of the power generator unit 3 which are not configured in pairs to reduce the significance of cogging torques, and thus the distribution of the internal torques is not uniform and vibrations are produced in the rotation direction easily. Therefore, the power generation device 1 may be damaged easily and may produce electromagnetic noises.

Therefore, it is a main subject of the present invention which develops a power generation device to achieve the effects of supplying the required electric power and electromagnetic resistance, as well as avoiding unnecessary waste of power, resisting vibration, and reducing electromagnetic noise.

### SUMMARY OF THE INVENTION

In view of the aforementioned problems of the prior art, it is a primary objective of the present invention which provides an electric power generation and brake device to overcome the problem of wasting power, resist vibration, and reduce electromagnetic noise.

To achieve the aforementioned and other objectives, the present invention provides an electric power generation and brake device disposed on a shaft and comprising a wheel, a stator unit, a rectifier unit, a control panel, a waveform generator unit, a DC power regulator unit, and a brake unit.

The wheel is movably and axially installed to the shaft, and the wheel comprises: an outer ring disposed around the edge of the wheel; an inner ring coaxially installed with the outer ring to the wheel, and situated between the outer ring and the axis of the wheel; and a plurality of permanent magnets spaced with each other and installed on a side of the inner ring facing towards the axis of the wheel.

The stator unit is fixed to the shaft by using the axis of the wheel as the center, and the stator unit comprises a stator body disposed between the inner ring of the wheel and the axis of the wheel; a plurality of first serrated portions disposed around the periphery of the stator body, and configured to be corresponsive to the permanent magnets respectively; and a plurality of electric generating coils wound around the first serrated portions, wherein, when the wheel rotates, the permanent magnets rotate with respect to the stator unit to generate an alternating current.

The rectifier unit is electrically coupled to the stator unit to convert the alternating current into a direct current; the control panel is electrically coupled to the rectifier unit; the waveform generator unit is electrically coupled to the control panel to generate an inverted torque input signal; and the DC power regulator unit is electrically coupled to the waveform generator unit.

The brake unit is fixed to the shaft or the stator body by using the axis of the wheel as the center, and electrically coupled to the DC power regulator unit to receive the direct current and the inverted torque input signal, and the brake unit comprises: a brake body disposed between the outer ring and the inner ring of the wheel; a plurality of second serrated portions disposed around the periphery of the brake body and configured to be corresponsive to the outer ring of the wheel; and a plurality of brake coils wound around the second serrated portions respectively; wherein the brake unit is provided for braking the wheel.

In the aforementioned electric power generation and brake device, the permanent magnets of the wheel have a total of 12 magnetic poles, and the stator unit has a total of 37 first serrated portions.

In the aforementioned electric power generation and brake device, the second serrated portions of the brake unit are arranged symmetrically with respect to the center of the brake body. Wherein, the brake unit has a total of 18 second serrated portions.

In addition, the present invention provides another electric power generation and brake device, which is substantially the same as the aforementioned electric power generation and brake device except the configuration and relations of the wheel, the stator unit and the brake unit.

The plurality of permanent magnets of the wheel are spaced with each other and disposed on a side of the outer ring facing towards the axis of the wheel; the stator body of the stator unit is disposed between the outer ring and the inner ring of the wheel; the brake body of the brake unit is disposed between the inner ring of the wheel and the axis of the wheel; and the second serrated portions of the brake unit are configured to be corresponsive to the inner ring of the wheel.

The present invention further provides a pedal fitness equipment, comprising: a base; the aforementioned electric power generation and brake device installed to the base; a pedal unit installed to the base; and a driving member for driving the wheel of the electric power generation and brake device.

In summation, the electric power generation and brake device of the present invention has the function of generating both electric power and electromagnetic resistance and achieves the effects of avoiding unnecessary waste of power and generating uniform and symmetric reverse torques to resist vibration, so as to reduce electromagnetic noise.

### BRIEF DESCRIPTION OF THE DRAWINGS

FIG. 1 is a schematic view of a conventional power generation device;

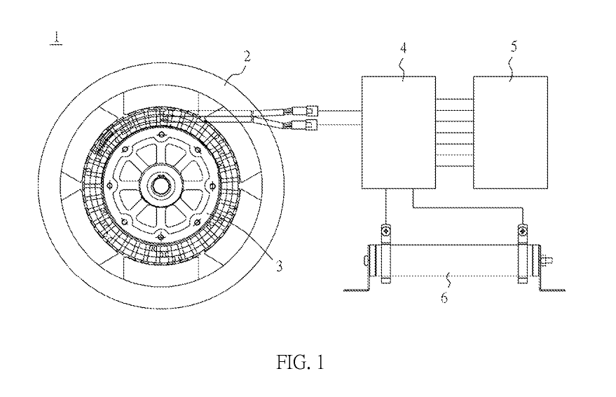

FIG. 2 is a schematic view of an electric power generation and brake device in accordance with a first preferred embodiment of the present invention;

FIG. 3 is a schematic view of an electric power generation and brake device installed to a pedal fitness equipment in accordance with the present invention;

FIG. 4 is a partial cross-sectional view of an electric power generation and brake device in accordance with the first preferred embodiment of the present invention;

FIG. 5 is a perspective view of a stator unit and a brake unit of an electric power generation and brake device combined with each other in accordance with the present invention;

FIG. 6 is a front view of a stator unit and a brake unit of an electric power generation and brake device combined with each other in accordance with the present invention; and

FIG. 7 is a schematic view of an electric power generation and brake device in accordance with a second preferred embodiment of the present invention.

### DESCRIPTION OF THE PREFERRED EMBODIMENTS

The technical characteristics, contents, advantages and effects of the present invention will become apparent from the following detailed description taken with the accompanying drawing.

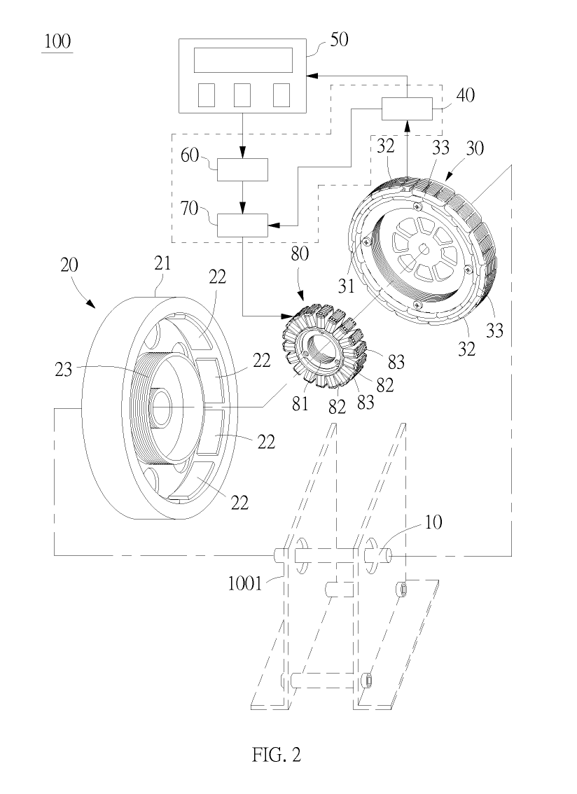

With reference to FIG. 2 for a schematic view of an electric power generation and brake device 100 of the present invention, the electric power generation and brake device 100 comprises a shaft 10, a wheel 20, a stator unit 30, a rectifier unit 40, a control panel 50, a waveform generator unit 60, a DC power regulator unit 70 and a brake unit 80. In an embodiment, the electric power generation and brake device 100 is installed to a pedal fitness equipment 1000. It is noteworthy that the electric power generation and brake device 100 may also be installed to other assemblies.

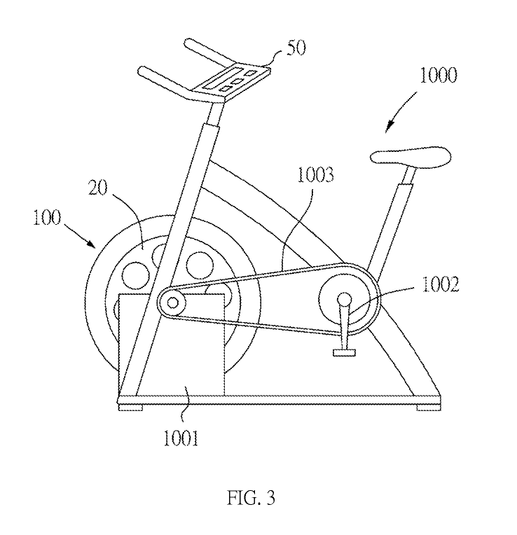

In FIGS. 2 and 3, the shaft 10 is axially installed to a base 1001 of the pedal fitness equipment 1000.

The wheel 20 is movably and axially installed to the shaft 10, and the wheel 20 comprises an outer ring 21, a plurality of permanent magnets 22 and an inner ring 23. The outer ring 21 is disposed around the edge of the wheel 20, and the permanent magnets 22 are spaced with each other and disposed on a side of the outer ring 21 facing towards the axis of the wheel 20. The inner ring 23 and the outer ring 21 are coaxially installed to the wheel 20, and disposed between the outer ring 21 and the axis of the wheel 20.

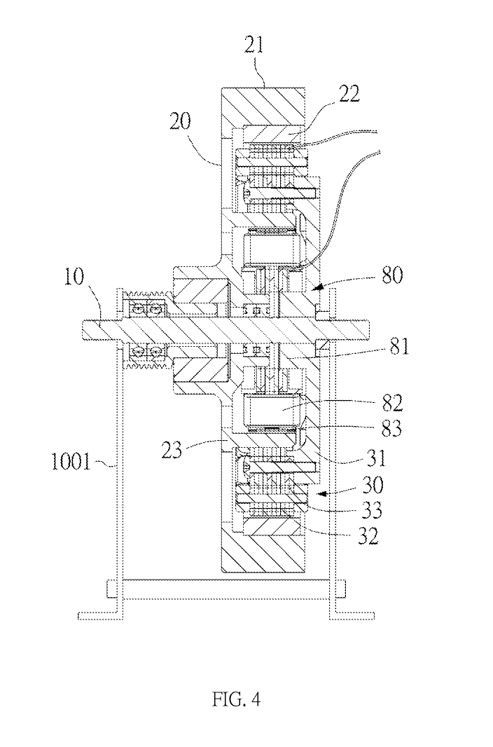

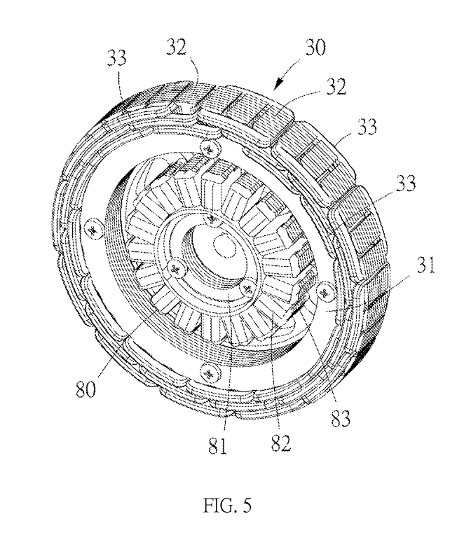

In FIGS. 2 to 5, the stator unit 30 is fixed to the shaft 10 by using the axis of the wheel 20 as the center, and the stator unit 30 comprises a stator body 31, a plurality of first serrated portions 32 and a plurality of electric generating coils 33. The stator body 31 is disposed between the outer ring 21 and the inner ring 23 of the wheel 20, and the first serrated portions 32 is disposed around the edge of the stator body 31, and the first serrated portions 32 are configured to be corresponsive to the permanent magnets 22 respectively. The electric generating coils 33 are wound around the first serrated portions 32. When the wheel 20 rotates, the permanent magnets 22 rotate with respect to the stator unit 30 to generate an alternating current.

The rectifier unit 40 is electrically coupled to the stator unit 30 for converting the alternating current into a direct current. The control panel 50 is electrically coupled to the rectifier unit 40 and provided for a user to control the pedal fitness equipment 1000. The waveform generator unit 60 is electrically coupled to the control panel 50 for generating an inverted torque input signal. The DC power regulator unit 70 is electrically coupled to the waveform generator unit 60. The rectifier unit 40, the waveform generator unit 60 and the DC power regulator unit 70 may be integrated as a controller module.

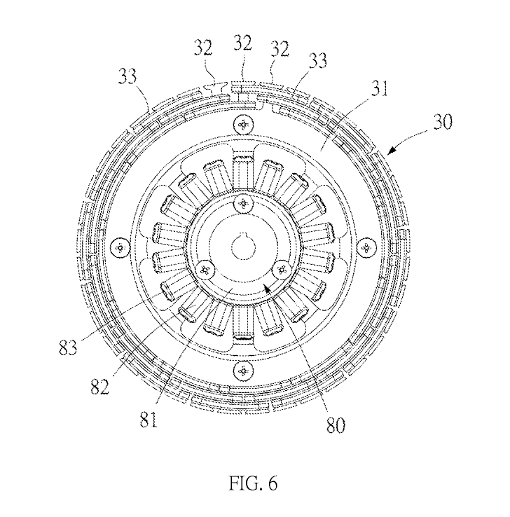

In FIGS. 2 to 6, the brake unit 80 is fixed to the stator body 31 by using the axis of the wheel 20 as the center, and the brake unit 80 is electrically coupled to the DC power regulator unit 70 for receiving the direct current and the inverted torque input signal. The brake unit 80 comprises a brake body 81, a plurality of second serrated portions 82 and a plurality of brake coils 83. The brake body 81 is disposed between the inner ring 23 of the wheel 20 and the axis of the wheel 20. The second serrated portions 82 are disposed around the edge of the brake body 81, and the second serrated portions 82 are configured to be corresponsive to the inner ring 23 of the wheel 20. The brake coils 83 are wound around the second serrated portions 82 respectively. After the brake unit 80 receives the direct current and the inverted torque input signal, a reverse torque (which is a force in the tangential direction) and an electromagnetic attraction force (which is a force in the radial direction) are generated to brake the wheel 20. It is noteworthy that the reverse torque is a force mainly used for braking the wheel 20 and the electromagnetic attraction force is a force mainly uses for assisting to brake the wheel 20. In addition, the brake unit 80 may be fixed to the shaft 10 (which is not shown in the figure).

Refer to FIGS. 2 to 4 again. The operation of the electric power generation and brake device 100 is described below.

Firstly, a user may step on a pedal unit 1002 (such as a pedal) of the pedal fitness equipment 1000 to drive the wheel 20 to rotate by a driving member 1003 (such as a belt), while the stator unit 30 and the brake unit 80 are remaining still.

When the wheel 20 is driven by the driving member 1003 to rotate, the permanent magnets 22 of the wheel 20 have effects on the first serrated portions 32 of the stator unit 30 and the electric generating coils 33 to generate the alternating current. The alternating current is transmitted to the rectifier unit 40 through an electric wire. The rectifier unit 40 converts the alternating current into the direct current. The direct current is transmitted to the control panel 50 and the DC power regulator unit 70 through an electric wire and the electric power is supplied to the control panel 50, so that the user may operate the control panel 50 to generate a control signal. The control signal transmitted from the control panel 50 is further transmitted to the waveform generator unit 60 through an electric wire to generate an inverted torque input signal. The inverted torque input signal generated from the waveform generator unit 60 is further transmitted to the DC power regulator unit 70 through an electric wire and then to the brake unit 80. Thus, the brake unit 80 generates a reverse torque and an electromagnetic attraction force.

Since the brake body 81 of the brake unit 80 is installed in the stator body 31 of the stator unit 30 and configured to be corresponsive to the inner ring 23 of the wheel 20, therefore the reverse torque and the electromagnetic attraction force generated by the brake unit 80 may be used to control the rotation speed of the wheel 20 when the inner ring 23 of the wheel 20 is braked, so as to resist the vibration produced when the wheel 20 and the stator unit 30 are operated, and reduce the electromagnetic noise.

To reduce the significance of the cogging torque, the electric power generation and brake device 100 of the present invention includes a total of 12 magnetic poles of the permanent magnets 22 of the wheel 20, and the stator unit 30 includes a total of 37 first serrated portions 32. As described in the previous paragraph, the vibration can be resisted and the electromagnetic noise can be reduced since the brake body 81 of the brake unit 80 is installed in the stator body 31 of the stator unit 30 and configured to be corresponsive to the inner ring 23 of the wheel 20. Regardless of the permanent magnets 22 and the first serrated portions 32 being arranged in pairs, the effects of resisting vibration and reducing electromagnetic noise can be achieved.

Since the second serrated portions 82 of the brake unit 80 are arranged symmetrically with respect to the center of the brake body 81, therefore the reverse torque and the electromagnetic attraction force generated by the brake unit 80 are uniform and symmetric, so as to improve the effect for the brake unit 80 to resist vibrations produced during the operation of the wheel 20 and the stator unit 30. Wherein, the brake unit 80 has a total of 18 second serrated portions 82.

In summation of the description above, the electric power generation and brake device of the present invention effectively utilizes the electric power generated by the stator unit in the control panel and the brake unit to avoid unnecessary waste of power. In addition, the stator unit and the brake unit are configured to resist the vibrations produced during the operation of the wheel and the stator unit, so as to reduce electromagnetic noise.

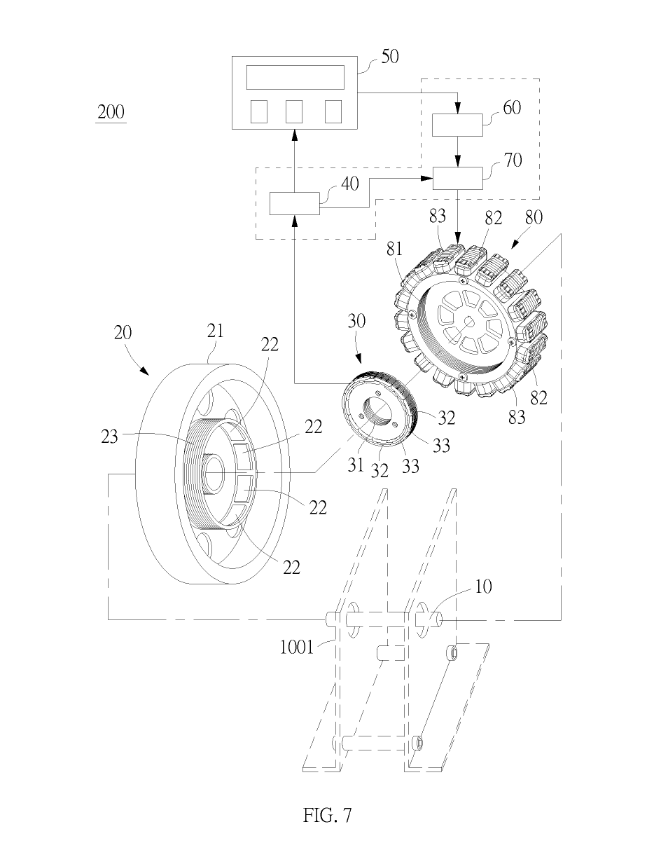

With reference to FIG. 7 for a schematic view of an electric power generation and brake device 200 in accordance with the second preferred embodiment of the present invention, the electric power generation and brake device 200 includes the same components as those of the electric power generation and brake device 100, except that the configuration and relation of the wheel 20, the stator unit 30 and the brake unit 80 are different from those of the first preferred embodiment.

Wherein, the electric power generation and brake device 200 comprises a shaft 10, a wheel 20, a stator unit 30, a rectifier unit 40, a control panel 50, a waveform generator unit 60, a DC power regulator unit 70 and a brake unit 80. The shaft 10 is axially installed to a base 1001 of the pedal fitness equipment.

The wheel 20 is movably and axially installed to the shaft 10, and the wheel 20 comprises an outer ring 21, a plurality of permanent magnets 22 and an inner ring 23. The outer ring 21 is disposed around the edge of the wheel 20. The inner ring 23 and the outer ring 21 are coaxially installed to the wheel 20, and disposed between the outer ring 21 and the axis of the wheel 20. The permanent magnets 22 are spaced with each other and disposed on a side of the inner ring 22 facing towards the axis of the wheel 20.

The stator unit 30 is fixed to the shaft 10 by using the axis of the wheel 20 as the center, and the stator unit 30 comprises a stator body 31, a plurality of first serrated portions 32 and a plurality of electric generating coils 33. The stator body 31 is disposed between the inner ring 23 of the wheel 20 and axis of the wheel 20. The first serrated portions 32 are disposed around the edge of the stator body 31, and the first serrated portions 32 are configured to be corresponsive to the permanent magnets 22 respectively. The electric generating coils 33 are wound around the first serrated portions 32. When the wheel 20 rotates, the permanent magnets 22 rotate with respect to the stator unit 30 to generate an alternating current.

The rectifier unit 40 is electrically coupled to the stator unit 30 for converting the alternating current into a direct current. The control panel 50 is electrically coupled to the rectifier unit 40. The waveform generator unit 60 is electrically coupled to the control panel 50 for generating an inverted torque input signal. The DC power regulator unit 70 is electrically coupled to the waveform generator unit 60. The rectifier unit 40, the waveform generator unit 60 and the DC power regulator unit 70 may be integrated as a controller module.

The brake unit 80 is fixed to the stator body 31 by using the axis of the wheel 20 as the center, and the brake unit 80 is electrically coupled to the DC power regulator unit 70 for receiving the direct current and the inverted torque input signal. The brake unit 80 comprises a brake body 81, a plurality of second serrated portions 82 and a plurality of brake coils 83. The brake body 81 is disposed between the outer ring 21 and the inner ring 23 of the wheel 20. The second serrated portions 82 are disposed around the edge of the brake body 81, and the second serrated portions 82 are configured to be corresponsive to the outer ring 21 of the wheel 20. The brake coils 83 are wound around the second serrated portions 82 respectively. After the brake unit 80 receives the direct current and the inverted torque input signal, a reverse torque (which is a force in the tangential direction) and an electromagnetic attraction force (which is a force in the radial direction) are generated to brake the wheel 20. It is noteworthy that the reverse torque is a force mainly used for braking the wheel 20 and the electromagnetic attraction force is a force mainly uses for assisting to brake the wheel 20. In addition, the brake unit 80 may be fixed to the shaft 10 (which is not shown in the figure).

When the wheel 20 rotates, the permanent magnets 22 of the wheel 20 have effects on the first serrated portions 32 of the stator unit 30 and the electric generating coils 33 to generate the alternating current. The alternating current is transmitted to the rectifier unit 40 through an electric wire. The rectifier unit 40 converts the alternating current into the direct current. The direct current is transmitted to the control panel 50 and the DC power regulator unit 70 through an electric wire and the electric power is supplied to the control panel 50, so that the user may operate the control panel 50 to generate a control signal. The control signal transmitted from the control panel 50 is further transmitted to the waveform generator unit 60 through an electric wire to generate an inverted torque input signal. The inverted torque input signal generated from the waveform generator unit 60 is further transmitted to the DC power regulator unit 70 through an electric wire and then to the brake unit 80. Thus, the brake unit 80 generates a reverse torque and an electromagnetic attraction force.

Since the brake body 81 of the brake unit 80 is configured to be corresponsive to the outer ring 21 of the wheel 20, therefore the reverse torque and the electromagnetic attraction force generated by the brake unit 80 may be used to control the rotation speed of the wheel 20 when the outer ring 21 of the wheel 20 is braked, so as to resist the vibration produced when the wheel 20 and the stator unit 30 are operated, and reduce the electromagnetic noise.

Since the second serrated portions 82 of the brake unit 80 are arranged symmetrically with respect to the center of the brake body 81, therefore the reverse torque and the electromagnetic attraction force generated by the brake unit 80 are uniform and symmetric, so as to improve the effect for the brake unit 80 to resist vibrations produced during the operation of the wheel 20 and the stator unit 30. In this way, the electric power generation and brake device 200 has the same effects as the electric power generation and brake device 100.

While the invention has been described by means of specific embodiments, numerous modifications and variations could be made thereto by those skilled in the art without departing from the scope and spirit of the invention set forth in the claims.

What is claimed is:

1. An electric power generation and brake device, disposed on a shaft, comprising:
a wheel movably and axially installed to the shaft and comprising:
an outer ring disposed around an edge of the wheel;
an inner ring coaxially installed with the outer ring to the wheel and situated between the outer ring and an axis of the wheel; and
a plurality of permanent magnets spaced with each other and installed on a side of the inner ring facing towards the axis of the wheel;
a stator unit fixed to the shaft by using the axis of the wheel as the center and comprising:
a stator body disposed between the inner ring of the wheel and the axis of the wheel;
a plurality of first serrated portions disposed around a periphery of the stator body and configured to be corresponsive to the permanent magnets respectively; and
a plurality of electric generating coils wound around the first serrated portions;
wherein, when the wheel rotates, the permanent magnets rotate with respect to the stator unit to generate an alternating current;
a rectifier unit electrically coupled to the stator unit to convert the alternating current into a direct current;
a control panel electrically coupled to the rectifier unit;
a waveform generator unit electrically coupled to the control panel and generating an inverted torque input signal;
a DC power regulator unit electrically coupled to the waveform generator unit; and
a brake unit fixed to the shaft or the stator body by using the axis of the wheel as a center and electrically coupled to the DC power regulator unit to receive the direct current and the inverted torque input signal, and the brake unit comprising:
a brake body disposed between the outer ring and the inner ring of the wheel;
a plurality of second serrated portions disposed around the periphery of the brake body and configured to be corresponsive to the outer ring of the wheel; and
a plurality of brake coils wound around the second serrated portions respectively;
wherein, the brake unit is provided for braking the wheel.

2. The electric power generation and brake device as claimed in claim 1, wherein the permanent magnets of the wheel have a total of 12 magnetic poles, and the stator unit has a total of 37 first serrated portions.

3. The electric power generation and brake device as claimed in claim 1, wherein the second serrated portions of the brake unit are arranged symmetrically with respect to a center of the brake body.

4. The electric power generation and brake device as claimed in claim 3, wherein the second serrated portions of the brake unit has a total of 18 second serrated portions.

5. The electric power generation and brake device as claimed in claim 2, wherein the second serrated portions of the brake unit are arranged symmetrically with respect to a center of the brake body.

6. The electric power generation and brake device as claimed in claim 5, wherein the second serrated portions of the brake unit has a total of 18 second serrated portions.
